(19) United States
(12) Patent Application Publication
(10) Pub. No.: US 2021/0279685 A1
(43) Pub. Date: Sep. 9, 2021

(54) CONTRACTOR AND CLIENT BIDDING FACILITATION APPLICATION AND METHOD

(71) Applicant: Robin Crockett, Minneapolis, MN (US)

(72) Inventor: Robin Crockett, Minneapolis, MN (US)

(21) Appl. No.: 17/192,628

(22) Filed: Mar. 4, 2021

Related U.S. Application Data
(60) Provisional application No. 62/987,056, filed on Mar. 9, 2020.

(51) Int. Cl. G06Q 10/10; G06Q 10/06; G06Q 10/04

(52) U.S. Cl. CPC G06Q 10/103; G06Q 10/04; G06Q 10/063112; G06Q 10/06312

(57) ABSTRACT

A contractor and client bidding facilitation application and method includes a bidding program on a personal computing device which is used to place information from client files on a server. The client files include project data and client personal information. The project data will further include one or more videos describing the project. Contractor files stored on the server include contractor contact information. The project data is entered by a client onto one of the personal computing devices and the client selects preferred contractors from a list of potential contractors accessed by the bidding program. The project data is then sent to the preferred contractors such that the project data can be studied and bid on by the preferred contractors. The bidding program further allows video communication between the client and contractors. Bids entered into the bidding program by the contractors so that one may be selected by the client.

### CROSS-REFERENCE TO RELATED APPLICATIONS

I hereby claim the benefit under 35 U.S.C. Section 119(e) of U.S. Provisional application 62/987,056 filed Mar. 9, 2020.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to contractor bidding program and more particularly pertains to a new bidding program for assisting a contractor in receiving information regarding potential projects in a format that will allow the contractor to provide an accurate bid to engage the project. The accuracy is enhanced by the program including access to stored videos of a project site that can be accessed by multiple contractors.

### (2) Description of Related Art Including Information Disclosed Under 37 CFR 1.97 and 1.98

The prior art relates to bidding programs that allow a contractor to place a bid on a proposed project but such programs do not allow for saved videos and combined video conferencing to facilitate information sharing between a contractor and a client.

### BRIEF SUMMARY OF THE INVENTION

An embodiment of the disclosure meets the needs presented above by generally comprising storing information on at least one server. The information includes a plurality of client files each associated with a different client. Each of the client files may particularly include client contact information and project data specifying a task to be completed by a client. The project data will include the type of project to be completed and its scope but will further include one or more videos captured by the client depicting the project area and discussing its various attributes. The information being stored further includes a plurality of contractor files each associated with a different contractor. The contractor files include contractor contact information and may further include completed tasks performed by the contractor for review by the client. A bidding program is provided and will typically be placed on a plurality of personal computing devices. The bidding program is in communication with the at least one server. Project data associated with a prospective project is entered by a client onto one of the personal computing devices and the project data is sent to the at least one server. The client searches of a list of potential contractors accessed by the bidding program and selects one or more preferred contractors from the potential contractors. The project data is then sent to the preferred contractors such that the preferred contractors can access the project data via the bidding program. Video communication by way of the bidding program can be initiated between the client and selected ones of the preferred contractors. Bids are entered into the bidding program for the prospective project by the contractors such that the bids are received by the client. Thereafter, one of the bids is selected by the client.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic view of a contractor and client bidding facilitation application and method according to an embodiment of the disclosure.

FIG. 2 is a schematic view of an embodiment of the disclosure.

### DETAILED DESCRIPTION OF THE INVENTION

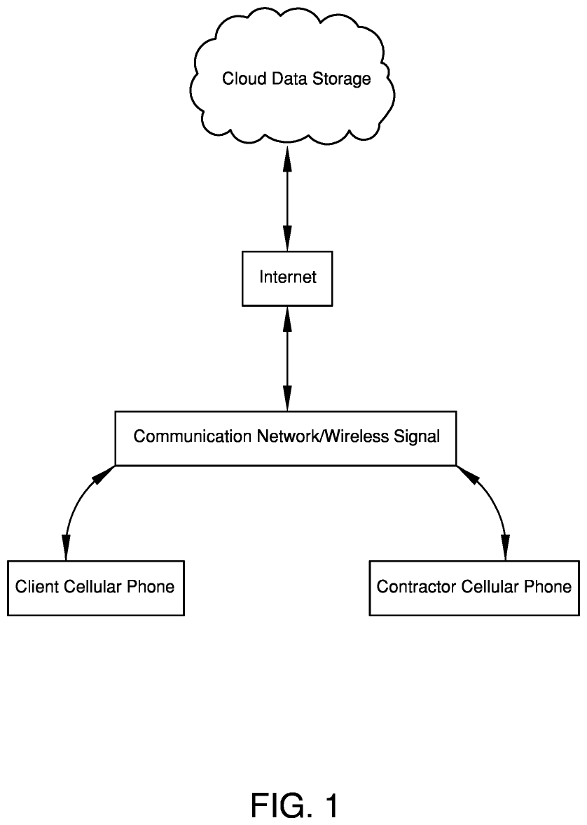

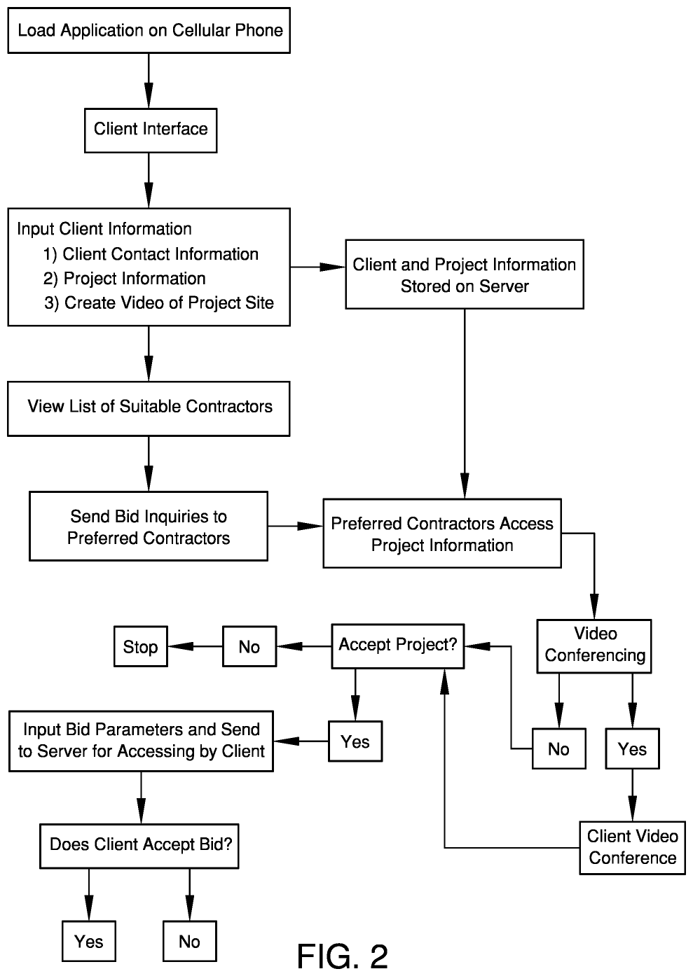

With reference now to the drawings, and in particular to FIGS. 1 and 2 thereof, a new bidding program embodying the principles and concepts of an embodiment of the disclosure and generally designated by the reference numeral 10 will be described.

As best illustrated in FIGS. 1 and 2, the contractor and client bidding facilitation application and method 10 generally comprises a program, method and system which allows for a client user to easily find and locate a contractor for a particular task. Furthermore, the method 10 provides a means for the contractor to have a remote, and yet thorough, understanding of the task such that the contractor can provide an accurate bid to the client. Thus, the application allows for an efficient mode of communication between the client and the contractors to facilitate the initiation of a required task. While the tasks envisioned will often include building projects of various sizes, the tasks may include other manual labor efforts such as large-scale cleaning, painting, flooring, roofing or other like tasks.

Specifically, the method 10 is partially embodied in an application, or program, which is placed on a personal computing device. The personal computing device is conventional and may include desktop computers, laptop computers, tablet computers and the like though most typically the personal computing device will comprise a cellular phone. The personal computing device will include a conventional display screen and an input means such as a keyboard or touchscreen. The application communicates by way of the internet to one or more servers for storing data. The one or more servers may also be referred to as the “cloud” as is commonly defined as one or more remote storage facilities accessible by the internet.

The application is placed on the personal computing device by the user who is a prospective client requiring a task, i.e. project, to be accepted by a contractor. The application includes a client side for those who have projects requiring a bid and a contractor side for contractors to place bids on the projects.

On the client side, the user will be provided with a plurality of data entry screens to enter the information required by a contractor and which will be sent to at least one server for future access. This will usually begin with the entry of personal information including name, address, telephone number, and email address. At some point in the data entry process the user will be prompted to select a password and may also be asked to select a unique username associated with what will become their client file.

The user will next enter project data regarding the type of project to completed. The project data may also include the timeframe in which the user would expect the project to be started and completed. The project data will, of necessity, be unique to the project and therefore may include any relevant information deemed requisite to preparing an accurate bid to complete the project. Thus, for example, should the project be a new deck, the project data may include variables such as size of the desired deck, materials to be used, demolition of an existing desk and the like. If the project is the cleaning of an industrial site, the project data may include the square footage of the industrial site, types of contaminants to be removed, if the cleaning includes surfaces outside of flooring, and other pertinent data. While the data should be as specific and complete as possible, as will be explained below there will be additional opportunities to supplement the project data.

An additional feature of the application is the ability to capture video of the area where the project is to occur. Thus, the user may use the application to video an area where flooring is to be installed so that a prospective contractor can view what state the current flooring is in to better estimate the time what will be required to complete the project. Furthermore, as the user is recording the video, the user's voice is also recorded explaining the project in more detail.

The application will provide the user with a plurality of suitable contractors and these may be arranged by type of project and also by location. The user can scroll through the contractors, i.e. potential contractors, to also see what types of projects each contractor has worked on as well as their completion rate. Additional information, such as reviews by other users, may be provided as well. The user selects preferred contractors from the potential contractors and upon selection the preferred contractors are sent the project data for the prospective project. The project data, including the video or videos captured by the user are retained on the at least one server for access by all contacted contractors.

On the contractor side, the contractor will use the application in the same initial manner and enter in personal or company information including name, address, phone number, email address, password and username. The application may include entry screens for adding information related to the contractor's or contractor's company's specific skillset or expertise. In this way, a contractor who only does cleaning services, for example, will not be mistaken for and contacted by a client who requires a new roof. The application may be designed to allow additional information from the contractor such as examples of prior work which can then be viewed by the client.

The application will divide the contractor's requested bids into pending bids, accepted bids and declined bids. Moreover, the application may be enabled to display completed bids as well. Bids which were accepted and have since been completed may be listed to and may be viewable by the client such that the client can make a self determination as to whether the contractor is completing bids in a timely and professional manner. Bids which are pending include the option for the contractor and the client to communicate with each other through a screen chat option on the application. Screen chatting is a conventional mode of communication and such communication within the bidding process will allow the contractor and client to a direct question/answer communication path and ensure a more accurate bid. The usage of remote and live video communication will also save valuable time to the contractor who otherwise might need to visit the location of the prospective project before tendering a bid to the client.

After the contractor has become familiar with the proposed project, the contractor can then submit a bid to the client or the contractor may decide to not place a bid. Should the client select that bid, the bid will then become an accepted bid. If the client does not accept the bid, the bid will become a declined bid. If the contractor's bid is declined, the application may be programmed to thereafter send to the contractor a message that the bid has been declined to allow the contractor to rebid the proposed project if the contractor is inclined to do so. Once a bid is accepted, the contractor will then move toward engagement of the project in a normal fashion.

As stated above, the application may include the ability for adding reviews of the contractors by the users as the work progresses or after it has been completed. Likewise, contractors may be able to review users such that other contractors can determine if a particular client is potentially difficult or pleasant to work with.

In one embodiment the method includes a bidding program utilized with a personal computing device that is used to store information on at least one server. The information includes a plurality of client files each associated with a different client. The term “file” used herein is conventional nomenclature for organizing a particular set of data under a specific heading whether or not an entirety of the data from that particular set is in the same physical location. Each of the client files may particularly include client contact information and project data specifying a task to be completed by a client. The project data will include the type of project to be completed and its scope but will further include one or more videos captured by the client depicting the project area and discussing its various attributes. The information being stored further includes a plurality of contractor files each associated with a different contractor. The contractor files include contractor contact information and may further include completed tasks performed by the contractor for review by the client. This becomes contractor performance data that provides useful insights to the clients. The bidding program will typically be placed on a plurality of personal computing devices. The bidding program is in communication with the at least one server. Project data associated with a prospective project is entered by a client onto one of the personal computing devices and the project data is sent to the at least one server. The client searches of a list of potential contractors accessed by the bidding program and selects one or more preferred contractors from the potential contractors. The project data is then sent to the preferred contractors such that the preferred contractors can access the project data via the bidding program. Video communication by way of the bidding program can be initiated between the client and selected ones of the preferred contractors. Bids are entered into the bidding program for the prospective project by the contractors such that the bids are received by the client. Thereafter, one of the bids is selected by the client.

In use, the application and method 10 allows a user client to locate multiple contractors from which to receive bids. The contractors have the benefit of receiving concise information including access to recorded video as well the ability to engage in video chatting with the client. This allows contractors to pick which projects they would like to bid, learn more about the project as needed, and supply a bid without the need to travel in person to the project site. The method 10 consequently provides a means to facilitate extremely fast bid production and receipt between contractors and clients.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of facilitating a bidding process between a contractor and a customer, said method including the steps of:
storing information on at least one server, said information including:
a plurality of client files each associated with a different client, each of said client files including:
client contact information;
project data specifying a task to be completed by a client, said project data including one or more videos captured by the client;
a plurality of contractor files each associated with a different contractor, each of said contractor files including;
contractor contact information;
completed tasks performed by the contractor;
providing a bidding program on a plurality of personal computing devices, said bidding program being in communication with said at least one server;
entering project data associated with a prospective project by a client onto one of the personal computing devices and sending the project data to the at least one server to define one of the client files;
searching by the client of a list of potential contractors accessed by the bidding program and selecting one or more preferred contractors from the potential contractors, each potential contractor being defined by one of the contractor files;
sending the project data to the preferred contractors such that the preferred contractors can access the project data via the bidding program;
video communication between the client and selected ones of the preferred contractors via the bidding program;
entering bids into the bidding program by the preferred contractors for the prospective project such that the bids are received by the client; and
selecting one of the bids by the client.

2. The method of facilitating a bidding process between a contractor and a customer according to claim 1, wherein the step of providing a bidding program on a plurality of personal computing devices includes the personal computing devices comprising one or more cellular phones each having an internet connection via a cellular network, a display, a camera, and a microphone, the bidding program being downloaded onto the one or more cellular phones.

3. The method of facilitating a bidding process between a contractor and a customer according to claim 1, further including within the step of storing information on at least one service a step of creating the contractor files by the potential contractors, the creation of the contractor files including the step of entering contractor skills.

4. The method of facilitating a bidding process between a contractor and a customer according to claim 3, further including the step of creating a list of potential contractors before searching the list of potential contractors by the client, wherein the list of potential contractors only includes the contractor files including contractor skills that match the project data of the client.

5. The method of facilitating a bidding process between a contractor and a customer according to claim 1, before the step of entering bids into the bidding program the preferred contractors selecting between the options to accept the prospective project or decline the prospective project, wherein the step of entering a bid is only taken upon selecting the option to accept the prospective project.

6. A method of facilitating a bidding process between a contractor and a customer, said method including the steps of:
loading an application on a plurality of personal computing devices, at least a portion of the plurality of personal computing devices comprising cellular phones including a display, a camera, a microphone, and an internet connection via a cellular network or WiFi connection, the application defining a bidding program;
entering information by a client into the bidding program of one of the personal computing devices defining a client phone to create a client file stored on a server connected to the internet and in communication with each of the personal computing devices, the information of the client file including client contact information and a project, the project including project information comprising a video of a project site recorded by the cellular phone and a particular task to be performed, the video of the project site being recorded by the camera on the client phone;
transferring the client file to a server;
entering information by a plurality of contractors with the bidding programs of a plurality of the personal computing devices defining contractor phones to create a plurality of contractor files stored on the server, the information of the contractor file including contractor contact information, contractor specialties, and contractor task performance data;
communication between the server and multiple bidding programs to further include the steps of:
matching of the client file only with the contractor files containing the contractor specialty aligning with the particular task, the contractor files matching the client file defining suitable contractors;
displaying the contractor files of the suitable contractors on the client phone;
sending bid inquiries to one or more of the suitable contractors from the client phone, the suitable contractors receiving bid inquires sent from the client phone defining preferred contractors;
receiving the client file by the contractor phones of the preferred contractors;
video conferencing between the client phone and at least one of the contractor phones of the preferred contractors;
sending to the server an acceptance or a declination of the project by the contractor phones of the preferred contractors, the acceptance including a project bid;
receiving by the cellular phone the acceptances from the server;
sending to the server an acceptance or declination of the project bid by the cellular phone; and
receiving from the server by the personal computing devices the acceptance or declination of the project bid.
